(19) United States
(12) Patent Application Publication
(10) Pub. No.: US 2010/0169482 A1
(43) Pub. Date: Jul. 1, 2010

(54) Method And An Apparatus For Monitoring Multimedia Data

(75) Inventors: Yong Tang, Beijing (CN); Changzhong Ge, Beijing (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: H3C TECHNOLOGIES CO., LTD., Hangzhou (CN)

(21) Appl. No.: 12/645,139

(22) Filed: Dec. 22, 2009

(30) Foreign Application Priority Data
Dec. 31, 2008 (CN) 200810247455.8

(51) Int. Cl. G06F 15/173

(52) U.S. Cl. 709/224

(57) ABSTRACT

The present invention discloses a method for monitoring network multimedia data, comprising: analyzing network packets, identifying multimedia data carried in the packets; separating the multimedia data from the packets, and saving the data and the associated access information to a monitoring information base to be utilized for illegal information detection. This invention also discloses a monitoring apparatus to implement the network multimedia monitoring. The method and apparatus in this invention implement monitoring of the multimedia information travelling in the network.

### CROSS-REFERENCE TO RELATED APPLICATIONS

This application claims the benefit under 35 U.S.C. §119(a)-(d) of Chinese Application 200810247455.8 filed on Dec. 31, 2008.

### TECHNICAL FIELD

This invention relates in general to the filed of network monitoring and more particularly to a method and apparatus for monitoring multimedia data.

### BACKGROUND

The rapid growth of the Internet enables distribution of illegal information even while bringing convenience to peoples' lives.

Mature text detection techniques have efficiently prevented illegal information distribution, which was formerly spread through text-based emails and Web pages.

As technology develops, methods for spreading illegal information are being diversified. For example, sensitive words are replaced by pictures to escape illegal information detection and thereby spread widely. In addition, inappropriate websites use multimedia information such as images and videos, which cannot be fully detected by current detection technology. This causes harm to the Internet. In this case, the need has emerged for detection technology to support Internet growth by efficiently detecting illegal information in these forms in real time.

### SUMMARY OF THE INVENTION

To achieve the objectives, the present invention provides a method and a monitoring apparatus for monitoring network multimedia information.

The method for monitoring the multimedia data comprises: analyzing the network packets and identifying the multimedia data carried in the packets, and separating the multimedia data from the packets and saving the separated data and the related access information to the monitoring information base.

Preferably, the multimedia data comprises image information, and the related access information comprises an identification of the visitor who accesses the information, an identification of the owner of the information, and the access time.

Preferably, the image information comprises picture information, and the network packets are HTTP packets, wherein analyzing the packets and identifying multimedia data comprise: judging if the content-type field is image in the HTTP reply from the server in response to the HTTP GET operation, and identifying the HTTP packets with content-type field being image, and wherein separating multimedia data and saving it to the monitoring information base comprise: collecting the image data of the identified HTTP packet and the data of its sequential packets until the data of the complete image file is collected, and then saving such information as the image file, an identification of the server that provides the image file, an identification of the visitor to whom the image file is sent, and the access time to the monitoring information base.

Preferably, the image information comprises video information, and the network packets are HTTP packets, wherein analyzing network packets and identifying multimedia data comprise: monitoring the TCP connection in response to an HTTP GET request for video files, judging if the HTTP GET operation requests for video file type, and identifying the HTTP response that carries video file type, and wherein separating multimedia data and saving it to the monitoring information base comprise: separating video file from the identified HTTP response, and saving to the monitoring information base such information as the video file, an identification of the server that provides the video file, an identification of the visitor to whom the file is sent, and the access time.

Preferably, the video file comprises flash file, and the packets are RTP packets, wherein analyzing packets and identifying multimedia data comprises: identifying the related data type according to the PT value in the RTP packets, and wherein separating multimedia data from network packets comprises: separating multimedia data from at least one RTP packet according to the PT-associated multimedia type.

Preferably, the multimedia type is JPEG file, wherein separating multimedia data from at least one RTP packet according to the PT-associated multimedia type comprises: identifying the complete video frames for the JPEG file according to the timestamp, sequence number, and marker, and separating the frames to get the JPEG file, and wherein saving the separated multimedia data and the access-related information to the monitoring information base comprises: saving the JPEG file as well as the source IP address, destination IP address and access time obtained form the RTP packet to the monitoring information base.

Preferably, the multimedia type is H263 or H261 video file, wherein separating multimedia data from at least one RTP packet according to the PT-associated multimedia type comprises: identifying some complete intraframes for the H263 or H261 video file according to the timestamp, sequence number, and marker, and separating the frames to get some static image file from the video file, and wherein saving the separated multimedia data and the access-related information to the monitoring information base comprises: saving the static images as well as the source IP address, destination IP address and access time obtained from related RTP packet.

Preferably, the packets are P2P packets, wherein analyzing the packets and identifying the multimedia data carried in the packets comprise: monitoring a P2P metafile, which is used to obtain the piece size and the identifiers of the pieces to be transmitted; and buffering the complete piece, and based on both the complete piece identifier and the piece identifier in the P2P metafile, judging where the complete piece is in the transferred file.

If the complete piece is the file header piece and this piece contains video index information, the device saves the file format and video index information; if the complete piece is the file header piece without video index information, the device saves the file format only; if the complete piece is the video data piece, the device judges if the file format and video frame index information of this file is saved, and identifies the video data piece that saves such information.

Separating multimedia data from packets and saving the data to the monitoring information base comprise: obtaining a video data frame, and based on the file format and the video frame index forming the image file, and saving the image file and the source IP address, destination IP address and access time to the monitoring information base, and releasing the related video piece.

Preferably, the method further comprises: setting the primary lifetime for the file header piece that contains the video frame index, and releasing the piece when the lifetime expires and/or setting the secondary lifetime for the video pieces of the information related to the file format that is not saved. If the related file header piece is obtained before the secondary lifetime expires, the video data frames are obtained from the video pieces; otherwise, the video data pieces are released.

The apparatus for monitoring the multimedia data comprises: a monitoring module, which is used for analyzing packets and identifying multimedia information carried in the packets; and a separating module, which is used for separating multimedia data from packets and saving the derived data and the related access information to the monitoring information base.

Preferably, the monitoring module comprises: a primary HTTP monitoring module for judging if the content-type field is image in the HTTP reply from the server in response to the HTTP GET operation, and identifying the HTTP packets with content-type field being image, wherein the separating module comprises: a primary separating module for collecting the image data of the identified HTTP packet and the data of its sequential packets until the data of the complete image file is collected, and then saving such information as the image file, an identification of the server that provides the image file, an identification of the visitor to whom the image file is sent, and the access time to the monitoring information base.

Preferably, the monitoring module comprises: a secondary HTTP monitoring module for monitoring the TCP connection in response to an HTTP GET request for video files, judging if the HTTP GET operation requests for video file type, and identifying the HTTP response that carries video file type, wherein the separating module comprises: a secondary separating module for separating video file from the identified HTTP response that carries the video file, and saving such information as the video file, an identification of the server that provides the video file, an identification of the visitor to whom the file is sent, and the access time to the monitoring information base.

Preferably, the monitoring module comprises: an RTP monitoring module for identifying a related data type according to the PT value in the RTP packet, wherein the separating module comprises: an RTP separating module for separating multimedia data from at least one RTP packet based on the multimedia type associated with the PT value, and saving the separated data and access-related information to the monitoring information base.

Preferably, the RTP separating module comprises: a primary RTP separating module for identifying the complete video frame for the multimedia type being JPEG file according to the timestamp, sequence number, and marker, separating the content of the frame to get the JPEG file, saving the JPEG file as well as the source IP address, destination IP address and access time obtained from the RTP packet to the monitoring information base and/or a secondary RTP separating module for identifying some complete intraframes for the multimedia type being H263 or H261 video file according to the timestamp, sequence number, and marker, separating the content of the intraframes to get static images in the H263 or H261 file, saving the images as well as the source IP address, destination IP address and access time obtained from the RTP packet to the monitoring information base.

Preferably, the P2P monitoring module is used for monitoring a P2P metafile to obtain the piece size and the identifiers of the pieces to be transferred; buffering the complete piece, and, based on the buffered piece identifier and the P2P metafile identifier, identifying the location where the complete piece is in the transmitted file. If the complete piece is the file header piece and this piece contains video index information, the device saves the file format and video index information in the piece; if the complete piece is the file header piece without video index information, the device saves the file format only; if the complete piece is the video data piece, the device judges if the file format and video frame index information of this file is saved, and identifies video data piece that saves such information.

In this instance, the separating module comprises: a P2P separating module for obtaining video data frame, based on the file format information and the video frame index information, to form the image file, and saving the image file as well as the source IP address, destination IP address and access time to the information base.

Preferably, the P2P monitoring module is further used for: setting the primary lifetime for the file header piece that contains the video frame index, releasing the piece when the lifetime expires; and/or, setting the secondary lifetime for the video pieces of the information related to the file format that is not saved. If the related file header piece is obtained before the secondary lifetime expires, the video data frames are obtained from the video pieces; otherwise, the video pieces are released.

As is apparent, the present invention identifies the multimedia data by analyzing the packets in the network, separates the identified multimedia data, and saves it to the monitoring information base, to implement monitoring of the network multimedia data. Thereafter, the contents in the monitoring information base can be browsed manually or by other approaches to verify the illegal information and take proper actions accordingly.

### DESCRIPTION OF THE DRAWINGS

FIG. 1 is a flow chart of implementing multimedia data monitoring in a network according to an embodiment of the present invention.

FIG. 2 is a block diagram for multimedia information monitoring according to the embodiment of the present invention.

FIG. 3a through FIG. 3d show contents of the HTTP packet that carries image information according to embodiment I of the present invention.

FIG. 4 is a block diagram for the monitoring apparatus according to embodiment I of the present invention.

FIG. 5 is a block diagram for the monitoring apparatus according to embodiment II of the present invention.

FIG. 6 shows the format of an RTP packet.

FIG. 7 is a block diagram for the monitoring apparatus according to embodiment III of the present invention.

FIG. 8 is a block diagram for the monitoring apparatus according to embodiment IV of the present invention.

### DETAILED DESCRIPTION OF THE INVENTION

For a better understanding of the present invention, and to show more clearly how it may be carried into effect, reference will now be made, by way of example, to the accompanying drawings which aid in understanding an embodiment of the present invention and in which:

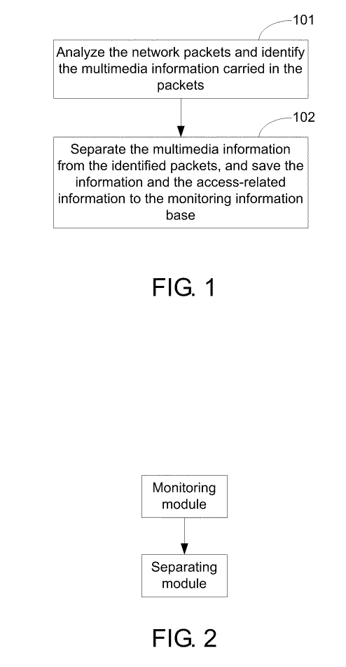

FIG. 1 is a flow chart of implementing multimedia data monitoring in a network according to an embodiment of the present invention. As shown in FIG. 1, the monitoring process comprises these steps:

At step 101, network packets are analyzed and multimedia data carried in the packets is identified.

The multimedia data comprises image information and/or audio information. The format and identifier of multimedia data vary depending on packets of different protocols.

At step 102, multimedia data are separated from the packets and the separated data and the related access information are saved to a monitoring information base.

Separating multimedia data from packets refers to extracting multimedia information. The related access information comprises an identification of the visitor who access the information, an identification of the owner of the information, and the access time.

The contents in the monitoring information base can be browsed manually or by other approaches to verify the illegal information and take proper actions accordingly. For example, the contents can be viewed by auto play or sampling to confirm the violations, preventing any identification mistakes or omissions.

FIG. 2 is a block diagram for multimedia data monitoring according to the embodiment of the present invention. As shown in FIG. 2, the apparatus comprises: a monitoring module and a separating module.

The monitoring module is used for analyzing packets and identifying multimedia information carried in the packets.

The separating module is used for separating multimedia data from the packets and saving the separated data and the related access information to the monitoring information base.

The following sections show embodiments for different protocol packets to illustrate the mentioned method and apparatus.

### Embodiment I

### Separating Picture Data Transferred Based on HTTP

In browser technology today, when a browser displays a Web page that contains image files, the browser first obtains the image file name and a path to the file. Then the browser sends an HTTP GET request for the image file. The server, upon receiving the request, sends back an HTTP response stating that the content-type is image, and at the same time sends the image file content to the browser. After the browser receives the HTTP response and the complete content of the image file, it displays the image for the user.

For example, consider a user is trying to open the website www.h3c.com. The website contains an image file of 12,258 bytes and named 20080508_{—}620431_h3community_{—}187441_{—}40_{—}0.gif. The browser will get the HTML file containing the following text:

<li><a href=“http://www.h3c.com/h3community” target=“blank”><img

src=“h3c_files/20080508_{—}620431_h3community_{—}187441_{—}40_{—}0.gif”

border=“0”></a></li>

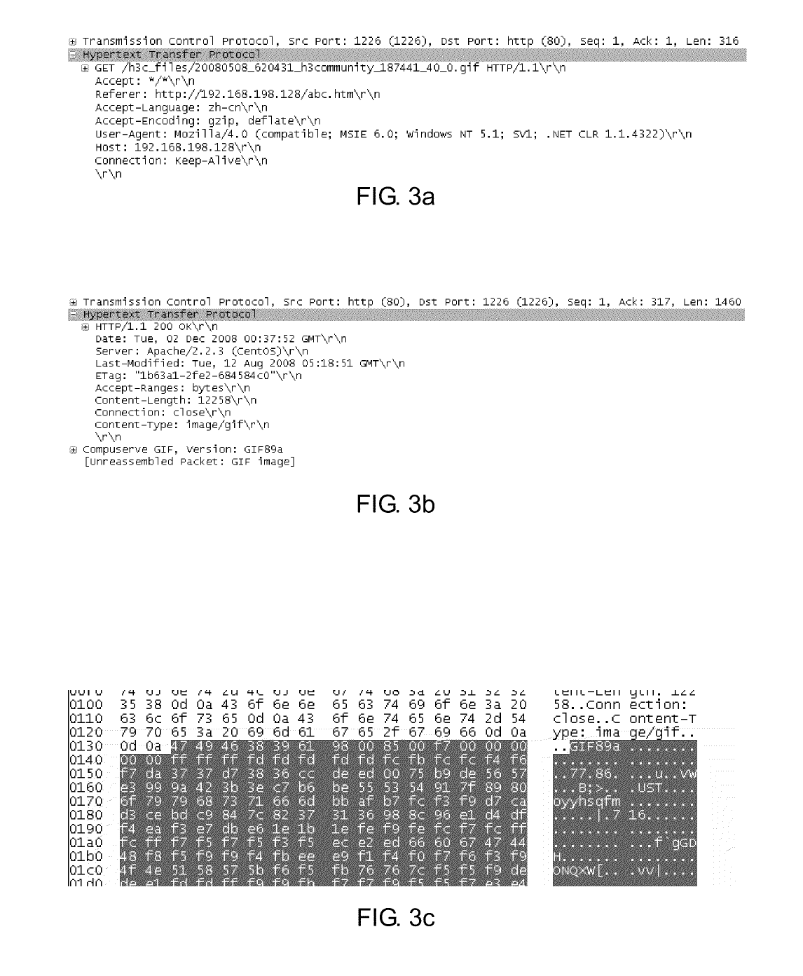

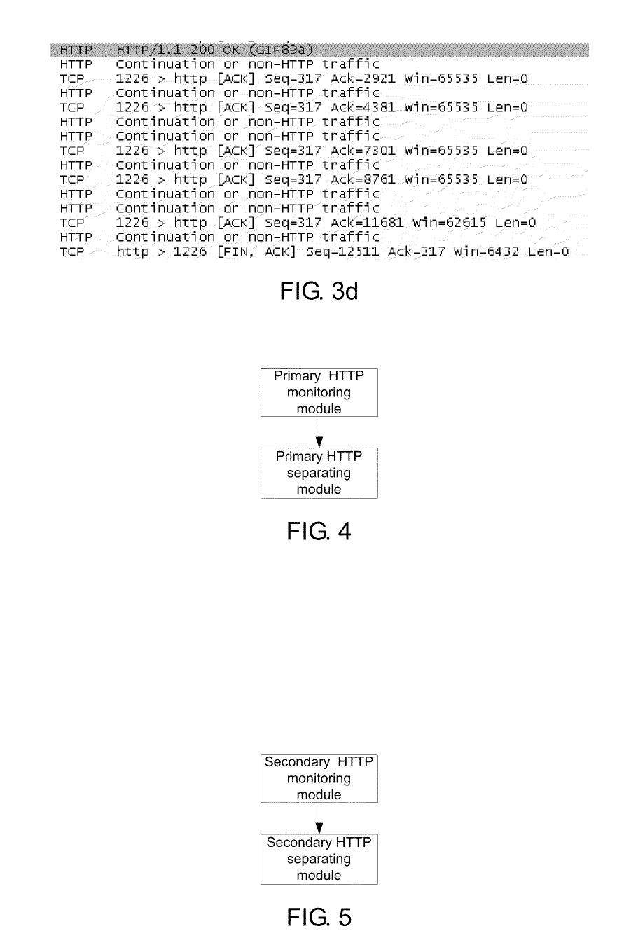

Once the file is obtained, the browser uses the string “src=“h3c_files/20080508_{—}620431_h3community_{—}187441_{—}40_{—}0.gif” in an HTTP GET request to the server, as shown in FIG. 3a.

Upon receiving the GET request, the server sends an HTTP response as shown in FIG. 3b. The HTTP response message contains information of content-type: image/gif and the first 1,208 bytes in the gif file, where the 1,208 bytes contents are those shaded in FIG. 3c.

Due to the limit of the IP packet size, the response packet only provides the first 1,208 bytes of the gif file. The server will send the remaining 11,050 bytes through a series of HTTP packets, as shown in FIG. 3d.

This implements the transmission of an image file embedded in the webpage.

The method for monitoring the multimedia information described in this embodiment is implemented by checking the HTTP response for the content-type of image. If it is an image, the image file data is transferred in the HTTP packet. After identifying the HTTP packet, the system collects the image data in the packet and the data of its sequential packets until the data of the complete image file is collected. Then the system saves the collected image file as well as an identification of the server that provides the image file, an identification of the user to whom the image file is sent, and the access time to the monitoring information base.

FIG. 4 is the block diagram for a monitoring apparatus according to embodiment I of the present invention. The monitoring module and separating module in the monitoring apparatus comprise a primary HTTP monitoring module and a primary HTTP separating module.

The primary HTTP monitoring module is used for judging if the content-type field is image in the HTTP reply from the server in response to the HTTP GET operation, and identifying the HTTP packet with content-type field being image.

The primary HTTP separating module is used for collecting the image data in this identified HTTP packet, and the data of its sequential packets until the data of the whole image file is collected. Then the system saves the collected image file as well as an identification of the server that provides the image file, an identification of the user to whom the image file is sent, and the access time to the monitoring information base.

### Embodiment II

### Separating Video Data Transferred Based on HTTP

Video data is always in a specific format, and this can help to judge if the HTTP GET requests a video file. If the request is for a video file, the system monitors the TCP connection associated with the HTTP GET request and later judges if the data is in the video file format in the HTTP response from the server. If it is, the system separates this video file, and save the video file, as well as an identification of the server that provides the video file, an identification of the user to whom the file is sent, and the access time to the monitoring information base.

Flash video may be taken as example. A flash-based video stream uses the FLV, SWF, or SWC format. Currently, most websites use an HTTP-based method to transmit FLV files. Details of an implementation are as follows. A website provides a link to a flash file. When a user clicks the link, the browser sends an HTTP GET request to get the flash file. Upon receiving the request, the server replies with the whole flash file in the HTTP packet. After receiving the flash file, the browser plays the flash file by using a player add-on. Some players immediately play the flash file before getting the whole file, reducing the wait time.

In this embodiment, the system checks the HTTP GET message for extension names of .flv, .swf, or swc to determine if a flash file is requested. If it is, the system monitors the TCP connection. After the server sends an HTTP reply, the system further checks if the data is in the flash file format. If it is, the system monitors the stream, separates the flash file, and saves the file as well as an identification of the server that provides the flash file, an identification of the user to whom the file is sent, and the access time to the monitoring information base.

FIG. 5 is the block diagram for the monitoring apparatus according to embodiment II of the present invention. As shown in FIG. 5, the monitoring module and separating module in the monitoring apparatus comprises a secondary HTTP monitoring module and a secondary HTTP separating module.

The secondary HTTP monitoring module is used for monitoring the TCP connection related to the HTTP GET request for video files, judging if the HTTP GET operation requests for video file type, and identifying the HTTP response that carries video file type.

The secondary separating module is used for separating video file from the identified HTTP response, and storing the video file as well as an identification of the server that provides the video file, an identification of the visitor to whom the file is sent, and the access time to the monitoring information base.

### Embodiment III

### Separating Multimedia Data Transferred Based on RTP

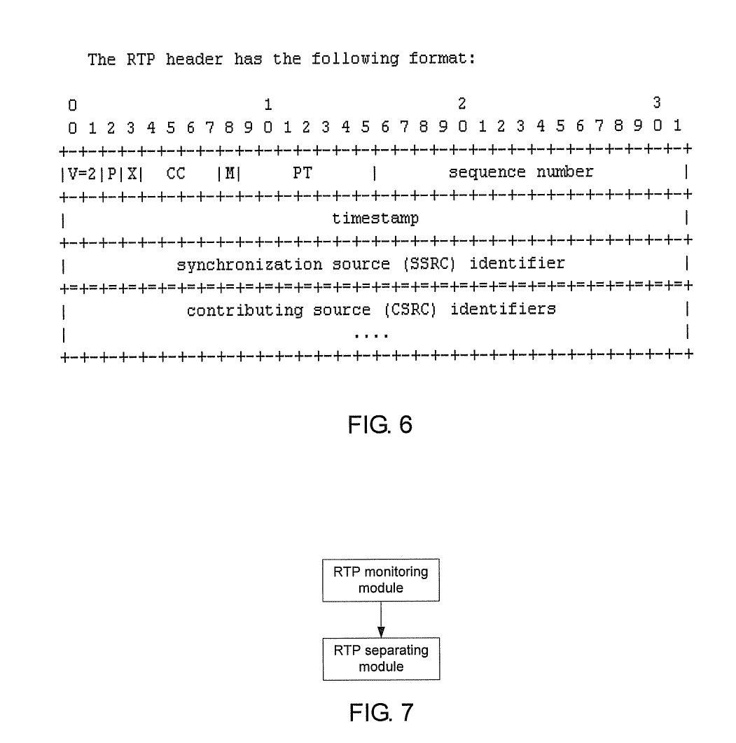

RTP protocol is widely used in multimedia services and the RTP packet is formatted as in FIG. 6.

In an RTP packet, the PT value represents the type of the payload. The following table describes the typical PT values.

TABLE 1

| | Encoding | Audio/ | Clock Rate | Channels |
|---|---|---|---|---|
| PT | Name | Video | (Hz) | (audio) |
| 26 | JPEG | V | 90000 | [RFC2435] |
| 31 | H261 | V | 90000 | [RFC3032] |
| 34 | H263 | V | 90000 | |

When several RTP packets are needed to transfer one video frame, they are buffered. To identify the RTP packets for one frame, the first, middle, and last packets are set with information in the RTP headers. In particular, when the first packet of a new frame follows the last packet of the last frame transferred, the Marker of the last packet is TRUE; the timestamp of the last packet is the same as that of the first packet, and the Marker of the last frame is TRUE; the timestamp of the middle packet is the same as that of the first packet, and the packets for the same frame are numbered with continuous sequence numbers. Therefore, the information in the RTP packet header of an RTP stream can be used to identify if the RTP packets forms a complete video frame. That is, the combination of timestamp+sequence number+marker in the RTP header determines a complete frame.

For example, for an RTP packet with a PT value being 26, the payload data is a JPEG file. In this case, the system identifies RTP packets for a complete video file based on timestamp, sequence number and marker, buffers the packets, separates the payload data from the packets. Then the system saves the separated data as a JPEG file to the monitoring information base together with the source IP address, destination IP address, and the access time.

For RTP packets with the PT value being H263 or H261, the payload data is a video file. Because the stream carries a large data volume, and is transferred for a relatively long time, to save the capacity of the monitoring information base, the system extracts some static images from the video file to reduce the amount of data to be saved. H.263 is a video codec standard designed as a low-bitrate compressed format for medium- and high-quality images. Its codec methods for motion videos are common, which divide the codec process into intraframe coding and interframe coding. The intraframe (I frame) contains all information to display itself, and cannot be made from other frames. Therefore, in this embodiment, the system identifies some I frames of the video according to the timestamp, sequence number and marker, separates these I frames, and generates one static image based on one I frame. Then the system saves the images to the monitoring information base together with the source IP address, destination IP address and the access time.

FIG. 7 is a block diagram for the monitoring apparatus according to embodiment III of the present invention. As shown in FIG. 7, the monitoring module and separating module in the monitoring apparatus comprise an RTP monitoring module and an RTP separating module.

The RTP monitoring module is used for judging the file type according to the PT value in the RTP packet and identifying the PT value associated with the multimedia type.

The RTP separating module is used for separating multimedia data from at least one RTP packet based on the multimedia type associated with the PT value, and saving the separated data and the access-related information to the monitoring information base.

In detail, the RTP separating module further comprises the primary RTP separating module and/or the secondary RTP separating module (not listed in FIG. 6).

The primary RTP separating module is used for identifying the complete video frame according to the timestamp, sequence number, and marker for the multimedia data being of JPEG type, separating the contents of the frame to get the JPEG file, saving the JPEG file as well as the source IP address, destination IP address and access time obtained from the RTP packets to the monitoring information base.

The secondary RTP separating module is used for identifying some complete intraframes according to the timestamp, sequence number, and marker for the multimedia data being of H263 or H261 type, separating the contents of the intraframes to get some static images in the H263 or H261 file, saving the images as well as the source IP address, destination IP address and access time obtained from the RTP packet to the monitoring information base.

### Embodiment IV

### Separating Multimedia Data Transferred Based on P2P

P2P-based applications transmit excessive data volumes, where video files consume the most part. It is necessary to monitor such data streams.

The following describes monitoring on video file transmission of a typical P2P application known as BitTorrent (BT for short).

BT usually splits a file into several pieces of the same length (the last piece may be smaller than this length) for transmission. The length of a piece is configured in a “.torrent” file and generally is 256 KB, 512 KB, or 1 MB.

When a .torrent metafile passes a networking device, the device monitors the metafile according to the piece size and an identifier (such as a SHA-1 index) in the file.

The networking device buffers a number of BT piece message packets depending on its storage size over a period of time. Once these pieces form a complete piece, the device is able to judge the location where the piece is in the transmitted file according to the SHA-1 of the piece or the SHA-1 information in the .torrent metafile.

For a file header piece, the device analyzes its format of the video file. If this piece contains the video frame index, the device saves the piece, that is, the file format information and the video frame index information. If no such index is contained, the device records the file format information only and drops the piece.

For a video data piece, the device decides whether to save the file format information and the video frame index information (video frame index is needed to parse some videos). If such information is already saved, the device analyzes the piece data according to the saved information, extracts the data frames (such as the I frames in the H264 coding algorithm) from the piece to form an image file. Then the device saves the image file together with the source IP address, destination IP address and access time to the monitoring information base. Once the monitoring information is separated from the piece, the device releases the piece.

Further, the lifetime for a file header piece carrying the video index information can be configured. Once the timer expires, the device releases the piece and the device no longer separates the information from the sequential video frames following the released file header piece.

In addition, if a video data piece is generated, but the device does not detect the file header piece, the device sets a lifetime for the data piece. If the device obtains the file header before the timer expires, it extracts the information from the data piece and releases the piece. If the device does not obtain the filer header before the timer expires, it releases the video data piece.

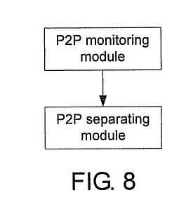

FIG. 8 is a block diagram for the monitoring apparatus according to embodiment IV of the present invention. As shown in FIG. 8, the monitoring module and separating module in the monitoring apparatus comprise a P2P monitoring module and a P2P separating module.

The P2P monitoring module is used for monitoring a P2P metafile to obtain the piece size and the identifiers of the pieces to be transferred; buffering the complete piece, and, based on the buffered piece identifier and the P2P metafile identifier; and identifying the location where the complete piece is in the transmitted file. If the complete piece is the file header piece and this piece contains video index information, the device saves the file format and video index information in the piece; if the complete piece is the file header piece without video index information, the device saves the file format only; if the complete piece is the video data piece, the device judges if the file format and video frame index information of this file is saved, and identifies video data piece that saves such information.

The P2P separating module is used for obtaining video data frames based on the file format and the video frame index information, extracting the video data frames from the video data pieces to form the image file, and saving the image file together with the source IP address, destination IP address and access time to the information base.

Further, the P2P monitoring module sets the primary lifetime for the file header piece that contains the video frame index, releases the piece when the lifetime expires, and/or, sets the secondary lifetime for the video data pieces of the information related to the file format that is not saved. If the related file header piece is obtained before the secondary lifetime expires, the video data frames are obtained from the video data pieces; otherwise, the device releases the video data pieces.

As is apparent, the present invention uses a monitoring module and a separating module to separate all multimedia data flowing through the device theoretically. In actual application, due to incomplete information, such as the packet loss of video streams transmitted in UDP packets, or the device processing performance limits, it is possible that not all valid information can be separated. Still with part of the image information, the monitoring works in actual application.

Although an embodiment of the invention and its advantages are described in detail, a person skilled in the art could make various alternations, additions, and omissions without departing from the spirit and scope of the present invention as defined by the appended claims.

1-17. (canceled)

18. In an apparatus communicatively coupled with a server and with a browser device, a method of monitoring multimedia data traversing a network, the method comprising:
at the apparatus, monitoring packet communications between the server and the browser device;
at the apparatus, analyzing network packets in the packet communications and identifying multimedia data carried in network packets sent from the server to the browser device; and
at the apparatus, separating the identified multimedia data and related access information from the network packets sent from the server to the browser device, and saving the separated multimedia data and the related access information to a monitoring information base, the monitoring information base being communicatively coupled with the apparatus.

19. The method of claim 18, wherein the multimedia data comprise image information,
wherein analyzing network packets in the packet communications and identifying multimedia data carried in network packets sent from the server to the browser device comprises identifying image information accessed from the server by a visitor associated with the browser device,
and wherein the associated access information comprises identity of the visitor, identity of an owner of the image information, and an access time at which the visitor accessed the image information.

20. The method of claim 18, wherein monitoring packet communications between the server and the browser device the network packets comprises identifying HTTP packets in the packet communications,
wherein the multimedia data comprise image data,
wherein analyzing network packets in the packet communications and identifying multimedia data carried in network packets sent from the server to the browser device comprises:
determining that an HTTP response from the server to an HTTP GET message from the browser device contains a content-type field set to image; and
identifying sequential HTTP packets sent from the server to the browser device that are associated with the HTTP response, and which each contain the content-type field set to image,
and wherein separating the identified multimedia data and related access information from the network packets sent from the server to the browser device, and saving the separated multimedia data and the related access information to a monitoring information base comprises:
collecting the image data from the HTTP response and from the identified sequential HTTP packets until a complete image file is assembled; and
saving to the monitoring information base the image file, an identity of the server, an identity of a visitor associated with the browser device, and an access time at which the visitor requested the image data.

21. The method of claim 18, wherein monitoring packet communications between the server and the browser device the network packets comprises identifying HTTP packets in the packet communications,
wherein the multimedia data comprise video data,
wherein analyzing network packets in the packet communications and identifying multimedia data carried in network packets sent from the server to the browser device comprises:
determining that an HTTP GET message from the browser device to the server includes a request for a video file type;
monitoring a TCP connection associated with the HTTP GET message; and
identifying in the monitored TCP connection an HTTP response from the server to the browser device that includes the video file type,
and wherein separating the identified multimedia data and related access information from the network packets sent from the server to the browser device, and saving the separated multimedia data and the related access information to a monitoring information base comprises:
separating one or more video files from the HTTP response; and
saving to the monitoring information base the one or more video files, an identity of the server, an identity of a visitor associated with the browser device, and an access time at which the visitor requested the video files.

22. The method of claim 21, wherein the one or more video files comprise one or more flash files.

23. The method of claim 18, wherein the network packets comprise RTP packets,
wherein analyzing network packets in the packet communications and identifying multimedia data carried in network packets sent from the server to the browser device comprises identifying one or more RTP packets having a payload type (PT) field value corresponding to a multimedia type,
and wherein separating the identified multimedia data and related access information from the network packets sent from the server to the browser device comprises:
separating multimedia data from the identified one or more RTP packets; and
identifying from the identified one or more RTP packets a source IP address, a destination IP address, and an access time at which the multimedia data was requested.

24. The method of claim 23, wherein the multimedia type is JPEG and the multimedia data comprise a JPEG file,
wherein separating multimedia data from the identified one or more RTP packets comprises:
identifying one or more complete video frames according to timestamps, sequence numbers, and markers in respective headers of the identified one or more RTP packets; and
separating from the identified one or more RTP packets the one or more complete frames to obtain the JPEG file,
and wherein saving the separated multimedia data and the related access information to a monitoring information base comprises saving to the monitoring information base the JPEG file, the source IP address, the destination IP address and the access time.

25. The method of claim 23, wherein the multimedia data comprises a video file selected from the group consisting of (i) an H263 video file corresponding to a multimedia type of H263 and (ii) an H261 video file corresponding to a multimedia type of H261,
wherein separating multimedia data from the identified one or more RTP packets comprises:
identifying one or more complete intraframes according to timestamps, sequence numbers, and markers in respective headers of the identified one or more RTP packets; and
separating the intraframes to obtain one or more static images from the video file,
and wherein saving the separated multimedia data and the related access information to a monitoring information base comprises saving to the monitoring information base the one or more static images, the source IP address, the destination IP address and the access time.

26. The method of claim 18, wherein the network packets comprise P2P packets and the multimedia data comprises a video file subdivided into one or more pieces, each including at least a piece identifier and piece data,
wherein analyzing network packets in the packet communications and identifying multimedia data carried in network packets sent from the server to the browser device comprises:
monitoring the P2P packets for a P2P metafile associated with the video file;
determining from the metafile a piece size of each of the one or more pieces and an identifier of each of the one or more pieces; and
for each respective piece of the one or more pieces: collecting one or more piece messages carried in one or more P2P packets until the respective piece is assembled in a buffer, and based on the piece identifier in the assembled, respective piece, a corresponding piece identifier in the P2P metafile, and the piece data of the assembled, respective piece, making a first determination of a location in the video file of the piece data of the assembled, respective piece,
and wherein separating the identified multimedia data and related access information from the network packets sent from the server to the browser device, and saving the separated multimedia data and the related access information to a monitoring information base comprises:
based on the first determination, assembling the video file from the piece data in each of the respective one or more pieces, and saving to the monitoring information base the assembled video file, a source IP address from which the video file was requested, a destination IP address to which the video file was sent, and an access time at which the video file was request.

27. The method of claim 26, wherein each of the one or more pieces is either a file header piece or a video data piece,
wherein making the first determination of the location in the video file of the piece data of the assembled, respective piece comprises:
if the assembled, respective piece is a file header piece, making a second determination to save file format information carried in the file header piece, and further to save video frame index information if video frame index information is also carried in the file header piece; and
if the assembled, respective piece is a video data piece, making a third determination of the location in the video file of the piece data according to file format information and video frame index information obtained and saved from the file header piece,
and wherein based on the first determination, assembling the video file from the piece data in each of the respective one or more pieces, and saving to the monitoring information base the assembled video file comprises:
for each respective piece of the one or more pieces:
if the assembled, respective piece is a file header piece, saving to the monitoring information base the file format information, and further saving the video frame index information according to the second determination;
if the assembled, respective piece is a video data piece, saving video data frames from the piece data to the video file in the monitoring information base according to the third determination; and
releasing the respective piece from the buffer.

28. The method of claim 27, further comprising:
for each respective piece of the one or more pieces:
if the assembled, respective piece is a file header piece, setting a primary lifetime timer after saving the data piece from a file header piece, and releasing the saved data piece from the file header piece when the primary lifetime timer expires; and
if the assembled, respective piece is a video data piece, setting a respective, secondary lifetime timer if the file format information and the video frame index information from the file header piece has not yet been saved, and releasing the assembled, respective piece from the buffer if the respective, secondary timer expires before the file format information and the video frame index information can be obtained and saved from the file header piece.

29. An apparatus for monitoring network multimedia data, the apparatus comprising:
a monitoring module configured to analyze network packets in packet communications between a server and a browser device, and to identify multimedia data carried in network packets sent from the server to the browser device; and
a separating module configured to separate the identified multimedia data and related access information from the network packets sent from the server to the browser device, and to save the separated multimedia data and the related access information to a monitoring information base.

30. The apparatus of claim 29, wherein the monitoring module comprises a primary HTTP monitoring module configured to:
determine that an HTTP response from the server to an HTTP GET message from the browser device contains a content-type field set to image; and
identify sequential HTTP packets sent from the server to the browser device that are associated with the HTTP response, and which each contain the content-type field set to image,
and wherein the separating module comprises a primary separating module configured to:
collect the image data from the HTTP response and from the identified sequential HTTP packets until a complete image file is assembled; and
save to the monitoring information base the image file, an identity of the server, an identity of a visitor associated with the browser device, and an access time at which the visitor requested the image data.

31. The apparatus of claim 29, wherein the monitoring module comprises a secondary HTTP monitoring module configured to:
determine that an HTTP GET message from the browser device to the server includes a request for a video file type;
monitor a TCP connection associated with the HTTP GET message; and
identify in the monitored TCP connection an HTTP response from the server to the browser device that includes the video file type,
and wherein the separating module comprises a secondary separating module configure to:
separate one or more video files from the HTTP response; and
save to the monitoring information base the one or more video files, an identity of the server, an identity of a visitor associated with the browser device, and an access time at which the visitor requested the video files.

32. The apparatus of claim 29, wherein the monitoring module comprises an RTP monitoring module configured to identify one or more RTP packets having a payload type (PT) field value corresponding to a multimedia type,
and wherein the separating module comprises an RTP separating module configured to:
separate multimedia data from the identified one or more RTP packets; and
identify from the identified one or more RTP packets a source IP address, a destination IP address, and an access time at which the multimedia data was requested.

33. The apparatus of claim 32, wherein the RTP separating module comprises a primary RTP separating module configured to:
identify one or more complete video frames of a JPEG file according to timestamps, sequence numbers, and markers in respective headers of the identified one or more RTP packets;
separate from the identified one or more RTP packets the one or more complete frames to obtain the JPEG file; and
save to the monitoring information base the JPEG file, the source IP address, the destination IP address and the access time.

34. The apparatus of claim 32, wherein the RTP separating module comprises a secondary RTP separating module configured to:
identify one or more complete intraframes of a video file according to timestamps, sequence numbers, and markers in respective headers of the identified one or more RTP packets, wherein the video file is selected from the group consisting of an H263 video file and an H261 video file;
separate the intraframes to obtain one or more static images from the video file; and
save to the monitoring information base the one or more static images, the source IP address, the destination IP address and the access time.

35. The apparatus of claim 29, wherein, the monitoring module comprises P2P monitoring module configured to:
monitor P2P packets for a P2P metafile associated with a video file that is subdivided into one or more pieces, wherein each of the one or more pieces includes at least a piece identifier and piece data;
determine from the metafile a piece size of each of the one or more pieces and an identifier of each of the one or more pieces; and
for each respective piece of the one or more pieces: collect one or more piece messages carried in one or more P2P packets until the respective piece is assembled in a buffer, and based on the piece identifier in the assembled, respective piece, a corresponding piece identifier in the P2P metafile, and the piece data of the assembled, respective piece, make a first determination of a location in the video file of the piece data of the assembled, respective piece,
and wherein the separating module comprises P2P separating module configured to:
based on the first determination, assemble the video file from the piece data in each of the respective one or more pieces, and save to the monitoring information base the assembled video file, a source IP address from which the video file was requested, a destination IP address to which the video file was sent, and an access time at which the video file was request.

36. The method of claim 35, wherein each of the one or more pieces is either a file header piece or a video data piece,
wherein the P2P monitoring module is configured to make a first determination of a location in the video file of the piece data of the assembled, respective piece by being configured to:
if the assembled, respective piece is a file header piece, make a second determination to save file format information carried in the file header piece, and further to save video frame index information if video frame index information is also carried in the file header piece; and
if the assembled, respective piece is a video data piece, make a third determination of the location in the video file of the piece data according to file format information and video frame index information obtained and saved from the file header piece,
